(19) United States
(12) Patent Application Publication
(10) Pub. No.: US 2017/0347437 A1
(43) Pub. Date: Nov. 30, 2017

(54) LIGHTING DEVICE

(71) Applicant: OSRAM GmbH, Munich (DE)

(72) Inventors: Juergen Hager, Herbrechtingen (DE); Jasmin Muster, Heidenheim (DE); Philipp Helbig, Heidenheim (DE)

(21) Appl. No.: 15/536,709

(22) PCT Filed: Dec. 10, 2015
(86) PCT No.: PCT/EP2015/079249

§ 371 Date: Jun. 16, 2017

(30) Foreign Application Priority Data
Dec. 19, 2014 (DE) 10 2014 226 661.0

(51) Int. Cl. H05B 37/03; F21V 7/00; F21K 9/64; H05B 37/02; G02B 27/30; F21Y 2115/30

(52) U.S. Cl. CPC H05B 37/03; H05B 37/0227; G02B 27/30; F21V 7/0091; F21K 9/64; F21Y 2115/30

(57) ABSTRACT

A lighting device with a conversion element is provided. It may be irradiated with excitation radiation from an electromagnetic radiation source. Provision is made of an optical component for the radiation emanating from the conversion element and provision is made of a sensor for detecting radiation emanating from the conversion element and/or for detecting radiation emanating from the radiation source.

### RELATED APPLICATIONS

The present application is a national stage entry according to 35 U.S.C. §371 of PCT application No.: PCT/EP2015/079249 filed on Dec. 10, 2015, which claims priority from German application No.: 10 2014 226 661.0 filed on Dec. 19, 2014, and is incorporated herein by reference in its entirety.

### TECHNICAL FIELD

The present disclosure proceeds from a lighting device comprising an electromagnetic radiation source for irradiating a conversion element with excitation radiation.

### BACKGROUND

The prior art has disclosed the LARP (laser activated remote phosphor) technology. Here, a conversion element is irradiated by an excitation beam (pump beam, pump laser beam) from an electromagnetic radiation source. Here, the conversion element includes a phosphor or consists of the latter. The radiation source is a laser light source or a light-emitting diode (LED). The excitation radiation entering into the conversion element is at least partly absorbed and at least partly converted into conversion radiation (emission radiation). The wavelength and hence the spectral properties and/or the color of the conversion radiation are determined, in particular, by the phosphor. The conversion radiation is irradiated in all spatial directions. If there is not a full conversion, the non-converted excitation radiation is also (at least in part, depending on layer thickness and scattering center concentration of the conversion element) irradiated or scattered in all spatial directions. The emission radiation irradiated from an element side is usually used further by optics.

A disadvantage herein is that, in the case of a fault, the excitation radiation or laser radiation may emerge in an undefined manner from a product using LARP technology, such as e.g. a laser module, and this harbors a risk for persons using the product.

### SUMMARY

The object of the present disclosure is to develop a lighting device with an electromagnetic radiation source which can be used safely.

This object is achieved by a lighting device in accordance with the features of claim 1.

Particularly advantageous configurations are found in the dependent claims.

According to the present disclosure, a remote phosphor lighting device or a lighting device includes a conversion element. The latter may be irradiated by excitation radiation from an electromagnetic radiation source. An optical component, in particular a refractive optical component, is provided for the radiation emanating from the conversion element. Advantageously, provision is made for at least one sensor (sensor element) for detecting radiation emanating from the conversion element and/or for detecting radiation emanating from the radiation source.

This solution is advantageous in that a change in the radiation captured by the sensor is detectable in a simple manner and it is hence possible to deduce a faulty operation of the lighting device.

The radiation source may be e.g. a laser light source. Here, provision may be made for a laser diode or a plurality of laser diodes which, for example, are used in a headlamp of a vehicle or automobile. Then, it is conceivable to produce e.g. white light or orange light using the lighting device. Here, the laser diode or the plurality of laser diodes are advantageously arranged in such a way that the excitation radiation thereof is guided onto the conversion element via one or more primary optical components. The spectral distribution of the radiation (light) radiated thereon is selected depending on the conversion dye or phosphor in the conversion element (remote phosphor target) and depending on the desired color of the target light distribution. By way of example, blue to violet excitation radiation (here, the wavelength lies between 400 nm and 480 nm) is used for generating white light. Here, the phosphor in the conversion element usually converts some of the excitation radiation into a spectrally relatively broad yellow-green-red radiation component or light component, as a result of which this is converted radiation. The remaining radiation component is partly absorbed by the conversion element and partly scattered. The light mixture of scattered light and converted light emanating from the conversion element leads to a spectrally white or orange or differently colored light when seen integrally (in the desired target solid angle).

In a further configuration of the present disclosure, the optical component consists, at least to the greatest extent, of silicone. As a result of this, the optical component may advantageously be produced using an injection molding method.

As a result of the comparatively good flow properties of silicone and the relatively low injection pressure during the injection molding method, a large design leeway is created for combining the sensor with the optical component, for example by virtue of the sensor being surrounded by the optical component. Moreover, silicone is very enduring in respect of irradiation by visible light, in particular blue light or UV light. Hence, the optical component made of silicone may be used very advantageously for the lighting device according to the present disclosure, in which high irradiation power densities occur. It is possible to determine that the combination of the lighting device with the optical component made of silicone is, inter alia, very advantageous for positioning the sensor or a plurality of sensors.

In particular, the optical component is configured in such a way that it is illuminated in full, or at least to the greatest possible extent, by the radiation emanating from the conversion element or at least from radiation emanating from an element side of the conversion element. Then, the light distribution may be generated using the optical component. By way of example, an exit surface of the optical element may be arched, structured or configured as a multifaceted free-form surface to this end.

The optical component advantageously is a collimator optics. Furthermore, the optical component in the form of the collimator optics may have a TIR (total internal reflection) surface.

The collimator optics may advantageously be configured, for example, as a paraboloid. Depending on the desired light distribution, a multifaceted free-form surface may also be used for the collimator surfaces, said free-form surface, in particular, being able to be screened. Alternatively, or additionally, it is conceivable for the collimator optics to have an input cutout in its entrance region for the radiation. By way of example, it has a cutout base which may serve as inner entrance surface. The cutout base may then, for example, be encompassed by a cutout edge which may serve as lateral entrance surface.

It would also be conceivable to produce the optical component from polycarbonate (PC), polymethylmethacrylate (PMMA) or glass.

Advantageously, the at least one sensor is provided to detect radiation converted by the conversion element. Additionally, at least one further sensor is advantageously provided in order to detect radiation that was not converted by the conversion element and possibly scattered. The sensors are able to detect a change in absolute radiation or a change in a ratio between converted and non-converted radiation. As a result of this, it is possible to determine a fault of the lighting device, for example that there no longer is a conversion of the excitation radiation in certain regions of the conversion element or that, overall, there no longer is a conversion of the excitation radiation or that some of the phosphor has fallen away, failed or broken off. If such a fault is identified, the radiation source may, for example, be switched off by way of an appropriate electronic circuit and other devices (body controller) may be informed in this respect.

If a fault is detected by the at least one sensor, provision may be made for spatially moving the optical component in such a way that no damaging radiation is able to emerge from the lighting device any more. By way of example, the component may be rotated and/or translated and/or deformed and/or defocused.

It would also be conceivable to prevent an emergence of damaging radiation by a movable shadowing element.

By way of example, the sensor is a semiconductor element (photodiode, phototransistor).

In a further configuration of the present disclosure, the sensor or the sensors may be arranged in the optical component. Advantageously, the sensor is insert molded into the optical component.

Electrical connectors for the at least one sensor may likewise be arranged or embedded in the optical component in sections. They are guided out of the optical component at a point that is suitable from an installation space point of view. By way of example, if the optical component broadens in a direction away from the conversion element, it is conceivable, for the electrical connectors to be guided out of the component in the direction toward the conversion element, since this facilitates a compact structure.

If the optical component has a TIR surface, the at least one sensor may be arranged in such a way that it detects the radiation reflected by the TIR surface during normal operation of the lighting device. By way of example, if the conversion element fails and the excitation radiation emanating from the radiation source radiates directly into the optical component, the at least one sensor is advantageously arranged outside of this radiation. Hence, no direct excitation radiation is incident on the sensor element in the case of a fault and the sensor is exposed to a lower illuminance during normal operation, allowing said sensor to be developed and designable in a more cost-effective manner, for example in respect of the material, the housing and/or a sensor power measurement range.

Advantageously, a position of the sensor is such that, during normal operation, the sensor and the electrical connectors shadow as little as possible from an optical point of view.

In a further configuration of the present disclosure, the at least one sensor may be arranged in such a way that, in particular during a faulty operating state of the lighting device, radiation essentially emerging directly from the conversion element or from the radiation source impinges on the sensor. Hence, the sensor is situated within the beam path of the excitation radiation, for example in the case of a failure of the conversion element. As a result of this, the excitation radiation may advantageously be detected directly in the case of a fault.

In a further advantageous embodiment of the present disclosure, the sensor is arranged in an edge region of an entrance surface of the optical component. Advantageously, the at least one sensor is then provided in the beam path between the entrance surface and the TIR surface of the optical component. The at least one sensor is therefore irradiated directly be radiation emanating from an entrance surface. If provision is made for a collimator optics, the at least one sensor may be arranged, for example, adjacently to the lateral entrance surface.

If the at least one sensor is arranged in the edge region of the entrance surface, an optical interference potential, which arises as a result of the at least one sensor, is reduced since the shadowing areas of the electrical connectors are reduced. Moreover, such a configuration of the lighting device is very compact since the sensor and the electrical connectors thereof may be arranged comparatively far inside when viewed in a radial direction proceeding from a longitudinal axis of the optical component.

In a further advantageous embodiment of the lighting device, the at least one sensor is arranged in an outer edge region of the optical component and advantageously insert molded into the component. Here the arrangement is advantageously brought about in such a way that the electrical connectors or supply lines to the sensor are arranged outside of the optical component. By way of example, the sensor may be irradiated e.g. directly by radiation entering into the optical component through the entrance surface in this arrangement.

In a further preferred embodiment of the present disclosure, the sensor is arranged adjacent to a mechanical functional region, for example a holding region, of the optical component. By way of example, if the optical component is configured as an elliptic paraboloid, the component broadens in a longitudinal direction, it being able to have an end portion which has approximately the same diameter and which, for example, is configured to be cylindrical. Then, the curved region of the component may have the TIR surface and the region adjoining this may, for example, serve for mechanical fixation of the component. If the at least one sensor is now arranged in the latter region or insert molded into the optical component in this region, the interference of an actively used region within the optical component, caused by the at least one sensor, is reduced. In this embodiment, the at least one sensor may, for example, also be irradiated directly by the radiation emanating from the entrance surface.

In a further configuration of the present disclosure, a mirror element (mirror) and/or a scattering element (diffuser element) may be arranged in the optical component. Here, the arrangement is advantageously brought about in such a way that the radiation entering into the optical component radiates directly, or via the TIR surface, to the mirror or scattering element and said radiation is guided from the latter to the at least one sensor. The radiation may be deflected to one or more sensors by the mirror element or the scattering element. If use is made of a scattering element, the latter advantageously leads to an elevation in a blue component of the radiation detectable by the sensor in the case of a fault. By way of example, the mirror element or the scattering element are insert molded into the optical component. Furthermore, the mirror element advantageously has a metallic configuration; however, it may also consist of a different material. Moreover, it is conceivable to configure the mirror to be curved or planar or any other shape, with this being carried out, in particular, depending on the requirements of the lighting device, into which the mirror element has been inserted.

In a further preferred embodiment, the at least one sensor is arranged in such a way that it is irradiated directly by the radiation emanating from the inner entrance surface if the collimator optics are used.

In a further preferred configuration of the present disclosure, the at least one sensor may also be arranged outside of the optical component. Hence the at least one sensor is not insert molded into the optical component, but may be held separately therefrom or on the latter. Additionally, provision may be made of providing the mirror element or the scattering element for guiding radiation from the optical component to the outside to the at least one sensor. The mirror element or the scattering element may in this case forward radiation which emanates from the TIR surface or which emanates directly from the entrance surface of the optical component. Advantageously, the mirror element or the scattering element is arranged and designed in such a way that the deflected radiation is incident on the TIR surface at such an angle that the TIR condition is not satisfied and therefore at least some of the deflected radiation may emerge from the optical component.

So that the mirror element or the scattering element may be insert molded into the optical component during the production, there is a need for a holding device which is able to hold the mirror element or the scattering element in a cavity during the injection molding method. Here, the holding element is advantageously arranged in such a way that it is arranged substantially behind the mirror in the direction of the radiation guided through the optical component and therefore lies, at least in sections, in the shadow of said mirror. It is conceivable for the holding element to remain in the optical component after the production. Alternatively, it may also be removed as part of an injection molding tool.

Advantageously, the at least one sensor may be configured as an SMD (surface-mounted device) component, which is arranged on a printed circuit board. Here, the printed circuit board may advantageously be provided outside of the optical component. In a further configuration of the present disclosure, the at least one printed circuit board with the at least one sensor may be arranged in the region of a curved outer surface of the optical component, which, for example, is the TIR surface. As a result of this, the lighting device has a very compact configuration.

If the at least one sensor is arranged outside of the optical component, the TIR surface may have a passage, for example in the form of matting, so that radiation from the optical component is able to radiate to the at least one sensor. The matting is e.g. a pyramid structure, a microlens structure or a microfacet structure, or any combination thereof or a diffuser (TIR condition partly or completely disturbed).

Advantageously, provision is made of two printed circuit boards with, in each case, at least one sensor. The printed circuit boards may be arranged symmetrically or asymmetrically in relation to a longitudinal axis of the optical component.

Advantageously, the two printed circuit boards are arranged approximately in a common plane and/or on the same side of the optical component.

In a further preferred embodiment of the present disclosure, a cutout may be introduced from the outside in the region of the TIR surface of the optical component. This may be a round or polygonal cutout surface or have a combination of a round and polygonal cutout surface. As a result of this, the TIR condition of the TIR surface may, at least in part, be infringed upon and the radiation may, at least in part, be incident on the at least one sensor arranged outside of the optical component. If the optical component consists of silicone, the undercut in the injection molding method required for the cutout may be demolded without additional outlay on account of the flexibility of the silicone. By contrast, if the optical component consists of PC or PMMA, such an undercut may only be demolded using a more complicated and more cost intensive tool, for example a slide mold. Moreover, it is conceivable for a passage (matting, pyramid structure, microlens structure or microfacet structure or any combination therefrom) to be introduced into the TIR surface in the region of the cutout.

Advantageously, the cutout is configured in such a way that, firstly, the at least one sensor may be arranged therein and, secondly, some of the radiation may be output coupled from the optical component over an area of the cutout. As a result of this, the at least one sensor is incorporated in a simple manner and compactly in the optical component. By way of example, the at least one sensor in this case is embodied as a conventional component with connection wires which are connected to a circuit board by way of so-called “pin soldering”. Alternatively, the at least one sensor may also be arranged on the printed circuit board as an SMD component.

In a further preferred embodiment of the present disclosure, the at least one sensor is arranged outside of the optical component in the region of the entrance surface in such a way that the radiation reflected by the entrance surface is incident on the at least one sensor. Then, the conversion element may also be provided in the region of the at least one sensor or of the entrance surface. The radiation reflected by the entrance surface then is, for example, a Fresnel back reflection. It is also conceivable to configure the entrance surface accordingly in the region in which the radiation is intended to be reflected to the sensor so that the reflected radiation is amplified. By way of example, the entrance surface may have the matting which leads to diffuse scattered radiation which, in turn, may be captured by the sensor.

In a further preferred embodiment of the present disclosure, at least one scattering center is provided in a spatial volume of the optical component. The spatial volume may be arranged in place of the mirror element. The scattering centers of the spatial volume may deflect some of the incident radiation to the sensor element. By way of example, it is also conceivable to provide a spatially extended diffuser element, insert molded into the optical component, in the spatial volume.

Advantageously, the optical component may also have a receiving cutout, into which the at least one sensor may be inserted and which may be undercut by the optical component. Hence, the at least one sensor is not insert molded into the optical component. By way of example, the receiving cutout has an approximately spherical configuration and a connection to the outside. Such a receiving cutout is very advantageously producible in the injection molding method if the optical component consists of silicone since such an undercut is comparatively complicated and would hardly be able to be realized in a conventional injection molding tool. Advantageously, the receiving cutout is embodied with the minimally necessary installation space. By way of example, the at least one sensor may be inserted or pressed into the receiving cutout and subsequently be fastened and/or positioned. The electrical connectors for the at least one sensor are configured as, for example, a mechanically comparatively rigid wire by way of the so-called “pin soldering”, or else as a flexible cable. The supply of the radiation to the at least one sensor may be provided in accordance with the aspects mentioned above. As an alternative to the spherical configuration of the receiving cutout, it is also conceivable for this to have a rather edged embodiment. By way of example, the receiving cutout may have an approximately trapezoidal or wedge-like configuration when seen in cross section.

Advantageously, the optical component may also have two receiving cutouts connected to one another, said receiving cutouts forming a type of dual-chamber form. Then, at least one sensor may be provided in a respective receiving cutout.

Advantageously, the receiving cutout or the connected receiving cutouts may be embodied in such a way that they can only be embodied with the optical component if the latter consists of silicone. By way of example, an undercut necessary for the receiving cutout may be extended in a plurality of spatial directions, which could not be implemented with a thermoplastic substrate such as e.g. PC or PMMA.

A web may be provided during the injection molding method for holding an element to be arranged in the optical component, such as e.g. the sensor or the mirror element or the diffuser element. This leads to the element being at least substantially stationary during the injection molding method, even though a force is exerted onto said element as a result of the inflow speed of the injection molding mass. In a further configuration, provision is advantageously made of two webs which each extend away from the element. Here, the webs may have a substantially straight line and/or be arranged at a predetermined angle in relation to one another. Here, the angle of the webs in relation to one another is advantageously configured in such a way that the webs, firstly, lead to sufficient stabilization of the element during the injection molding method and, secondly, have the smallest possible optical shadowing during the use of the optical component. By way of example, the webs are arranged in a V-shaped manner in relation to one another. Furthermore, they may extend along a plane which is arranged substantially perpendicular to a longitudinal axis of the optical component.

In a further preferred embodiment, a cavity may be provided in place of an element arranged in the optical component, such as e.g. the mirror element, or else an alternative to the matting in the optical component. Here, one or more cavity surfaces are embodied as TIR surfaces. The cavity may be open to the outside by way of a channel. Then, the TIR surfaces are able to guide the radiation toward the sensor element provided within or outside of the optical component. The channel advantageously extends in the radiation direction proceeding from the cavity, as a result of which, it may be arranged “in the shadow” of the cavity.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIGS. 1 to 27 each show, in a schematic illustration, an embodiment of a remote phosphor lighting device according to the present disclosure.

### DETAILED DESCRIPTION

In accordance with FIG. 1, a remote phosphor lighting device 1 (lighting device) is shown which, for example, is used in the automotive field.

In the following embodiments, only one sensor is depicted in part for reasons of clarity. In general, it is also possible to arrange a plurality of sensors, should this be required.

The lighting device 1 has an electromagnetic radiation source (not depicted here) in the form of a laser light source. The latter radiates excitation radiation 2 onto a conversion element 4. The latter includes a phosphor which at least partly converts the excitation radiation. Usually, some of the excitation radiation is not converted. Disposed downstream of the conversion element 4 is an optical component in the form of a collimator optics 6 which has an approximately funnel-shaped configuration. An outer lateral surface 8 of the optical component is configured as a TIR surface. Here, the outer lateral surface 8 broadens in a direction away from the conversion element 4 and has convex curvature when seen from the outside. The component 6 has an input cutout 10 for the entrance of the radiation emerging from the conversion element 4. Said input cutout has a cutout base which serves as inner entrance surface 12 and which is encompassed by a cutout edge which, in turn, serves as a lateral entrance surface 14. Moreover, the optical component 6 has an exit surface 16. A sensor 18 is arranged within the component 6. Said sensor is connected with the electrical connectors 20. The latter extend radially to the outside from the sensor 18 and are guided outside of the optical component 6 approximately in the direction of the conversion element 4. The sensor 18 is arranged in such a way that, during normal operation, radiation emanating from the conversion element 4, which enters into the component 6 through the lateral entrance surface 14 and which is reflected at the TIR surface 8, is detectable. By way of example, should the conversion element 4 fail, the excitation radiation 2 would directly enter into the optical component 6 as non-converted radiation and, in the process, would substantially not impinge on the sensor 18. Hence, the radiation detected by the sensor 18 would be reduced, providing an indication for a malfunction.

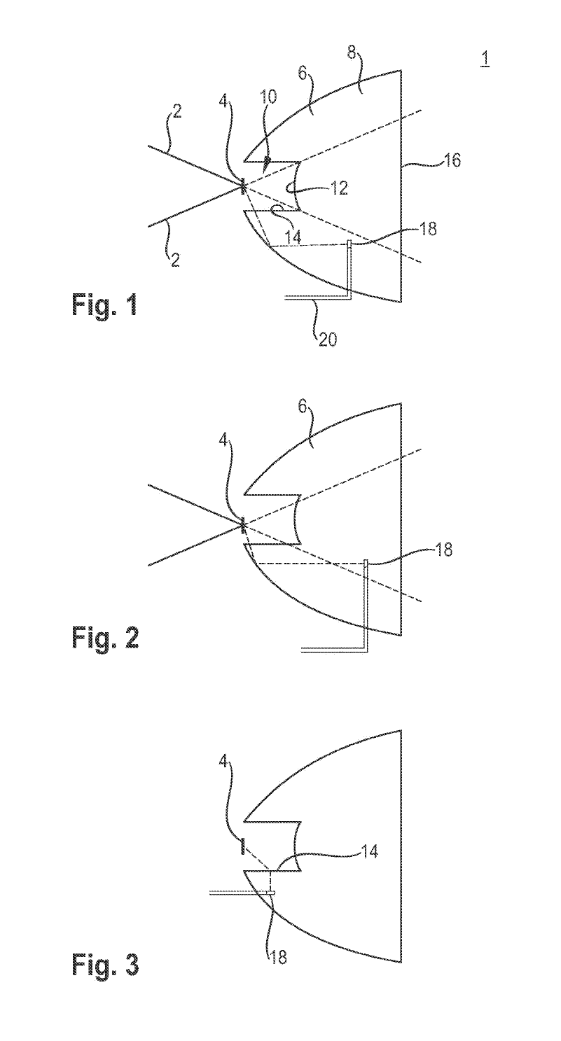

In accordance with FIG. 2, the sensor 18 is arranged closer to a longitudinal axis of the optical component 6 in contrast with FIG. 1. Therefore, in the case of a fault, it could be irradiated directly by non-converted radiation and therefore detect an increase in the non-converted radiation.

In FIG. 3, the sensor 18 is arranged in such a way that radiation emanating from the conversion element 4 impinges directly on the sensor 18 via the lateral entrance surface 14.

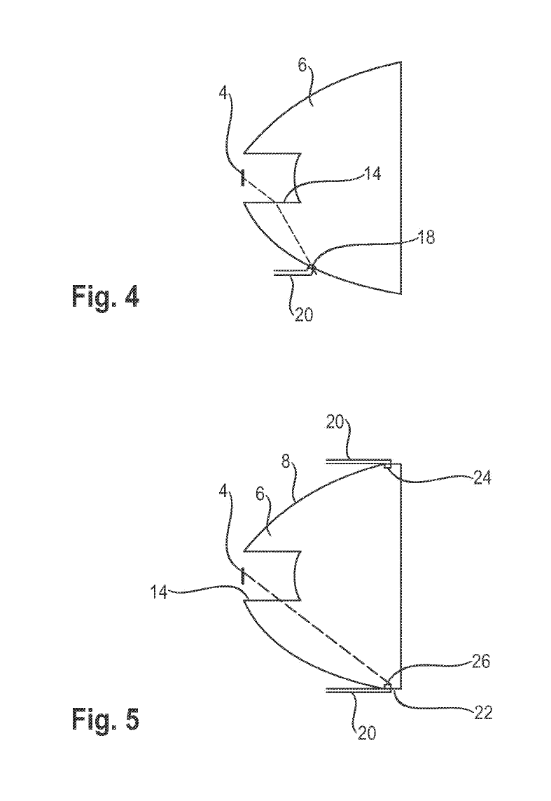

In accordance with FIG. 4, the sensor 18 is embedded at the edge of the optical component 6. Hence, the connectors 20 lie outside the component 6. Furthermore, the sensor 18 is irradiated directly by radiation emanating from the conversion element 4 via the lateral entrance surface 14.

In FIG. 5, a section 22, the curvature of which differs from the TIR surface 8, adjoins the funnel-shaped TIR surface 8 of the optical component 6 in a direction away from the conversion element 4. In accordance with FIG. 5, the section 22 has an approximately cylindrical external lateral surface. The optical component 6 may be mechanically affixed by way of this section 22. Two sensors 24 and 26 are arranged diametrically in relation to one another in the outer edge region of the section 22, the connectors 20 of said sensors being arranged outside of the optical component 6 and extending in the direction toward the conversion element 4. The sensors 24 and 26 are irradiated directly by the radiation emanating in the conversion element 4, said radiation entering into the component 6 via the lateral entrance surface 14.

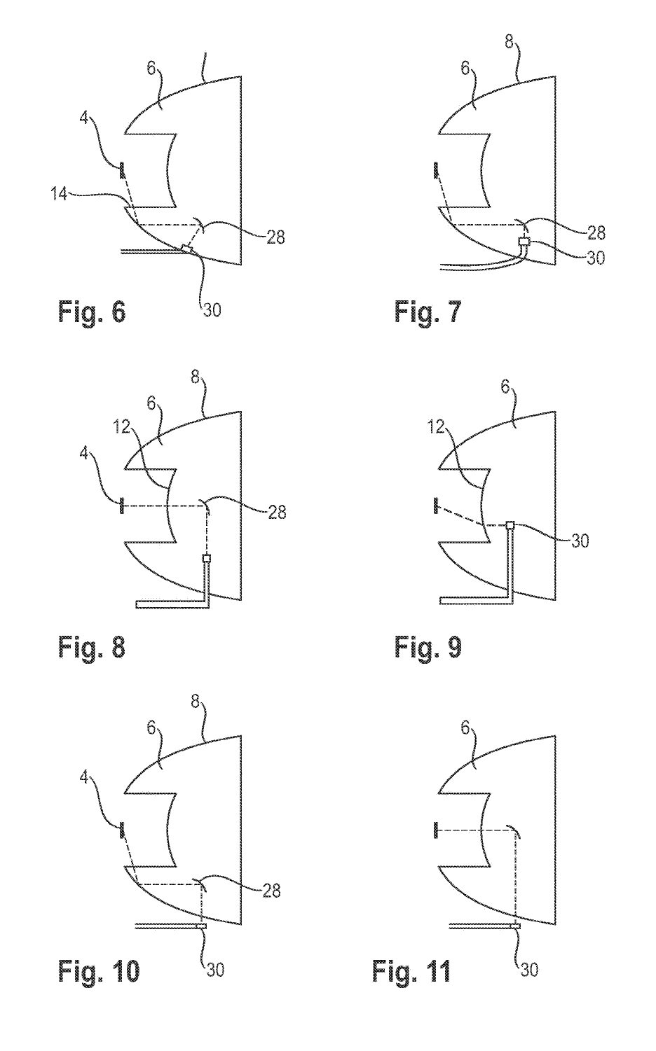

In FIG. 6, a mirror element 28 is embedded into the optical component 6, said mirror element deflecting the radiation from the conversion element 4 to the sensor 30. Here, in accordance with FIG. 4, the sensor 30 is arranged in the edge region of the optical component 6. The radiation which is deflected by the mirror element 28 emanates from the conversion element 4, enters into the component 6 via the lateral entrance surface 14 and is deflected to the mirror 28 via the TIR surface 8 and, thereupon, deflected to the sensor 30 via said mirror.

In accordance with FIG. 7, the sensor 30 is arranged within the optical component 6 in contrast to FIG. 6. Here, the sensor 30 is provided between the mirror element 28 and the TIR surface 8 in the radial direction of the optical component 6.

In FIG. 8, the mirror element 28 is provided approximately centrally in the optical component 6. Some of the radiation emanating from the conversion element 4, which reaches into the optical component 6 via the inner entrance surface 12, is guided from the mirror element 28 to the sensor 30.

In accordance with FIG. 9, the sensor 30 is arranged approximately centrally in place of the mirror element 28 from FIG. 8, as a result of which some of the radiation entering into the optical component 6 via the inner entrance surface 12 is detectable by the sensor 30.

In accordance with FIG. 10, the sensor 30 is arranged outside of the optical component 6 in contrast with the embodiment in FIG. 6. Hence, some of the radiation emanating from the conversion element 4 is deflected by the mirror element 28 to the outside, toward the sensor 30. Here, the arrangement of the mirror element 28 and of the sensor 30 is such that at least some of the radiation deflected by the mirror element 28 does not meet a TIR condition of the TIR surface and hence it is able to emerge from the optical component 6.

In accordance with FIG. 11, the sensor 30 is likewise arranged outside of the optical component 6, in contrast with FIG. 8.

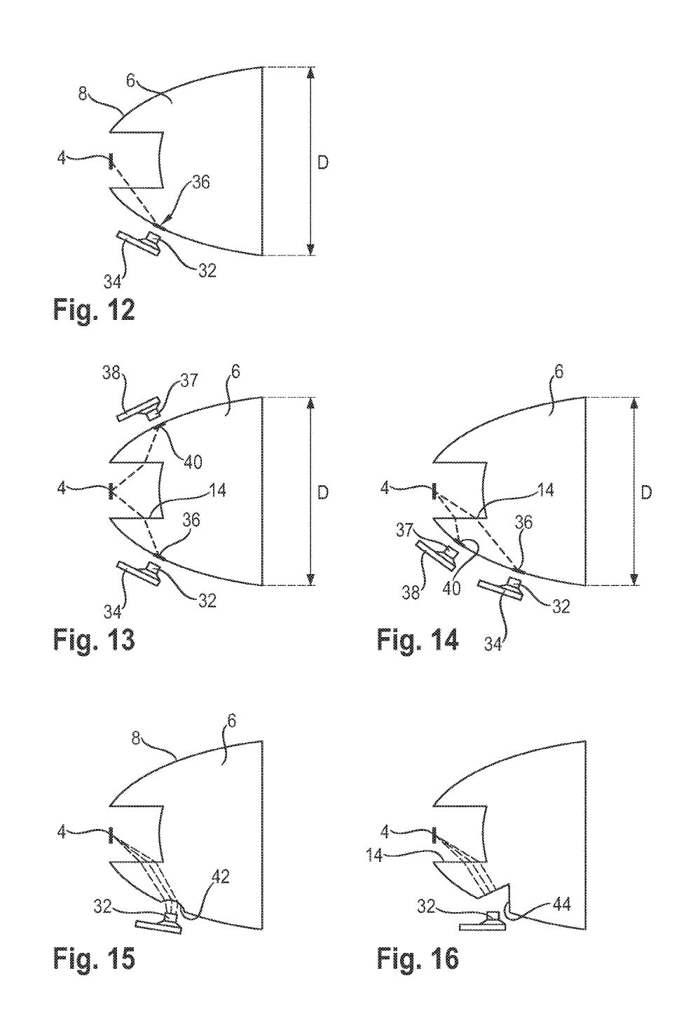

In FIG. 12, the sensor 32 is configured as an SMD component which is arranged on a printed circuit board 34. Here, the sensor 32, together with the printed circuit board 34, is arranged outside of the optical component 6. Here, the arrangement is effected adjacent to the TIR surface 8, with a maximum distance of the printed circuit board 34, together with the sensor 32, from a central longitudinal axis of the optical component 6 being smaller than half the maximum diameter D of the optical component 6. So that some of the radiation emanating from the conversion element 4 may be guided to the sensor 32, the TIR surface 8 has a passage 36 in the region in which this radiation is intended to emerge.

In FIG. 13, two sensors 32, 37 embodied as an SMD component are provided, said sensors in each case being arranged on a printed circuit board 34, 38, in contrast with FIG. 12. Here, the sensors 32, 37 with their printed circuit boards 34 and 38, respectively, are arranged diametrically in relation to one another on the optical component 6. Hence, the optical component 6 has a further passage 40 for the sensor 37. Here, in accordance with FIG. 12, the sensors 32 and 37 detect some of the radiation emanating from the conversion element 4, said radiation entering into the optical component 6 via the lateral entrance surface 14.

In accordance with FIG. 14, the sensors 32, 37 with their printed circuit boards 34, 38 are arranged on the same side of the optical component 6, approximately in a common plane. Here, both sensors 32, 37 detect some of the radiation emanating from the conversion element 4 by way of their passages 36 and 40, respectively, said radiation entering into the optical component 6 via the lateral entrance surface 14.

In accordance with FIG. 15, a cutout or recess 42 is introduced into the optical component 6 from the direction of the TIR surface 8. Said cutout or recess has an arched configuration in this case. Hence, a cutout surface of the cutout 42 has a different curvature than the TIR surface 8, wherein the TIR condition is at least partly infringed upon and hence some of the radiation emanating from the conversion element 4 is able to emerge from the optical component 6 and is detectable by the sensor 32. Said sensor is advantageously arranged adjacent to the cutout 42.

In contrast to FIG. 15, provision is made according to FIG. 16 of a cutout 44 with a different cross section. As seen in the cross section, the cutout 44 has an approximately V-shaped configuration. Therefore, it has e.g. two planar cutout surfaces, by means of which the TIR condition is at least partly infringed upon. As a result of this, in accordance with FIG. 15, some of the radiation emanating from the conversion element 4 may reach the sensor element 32 via the lateral entrance surface 14 and via the cutout 44.

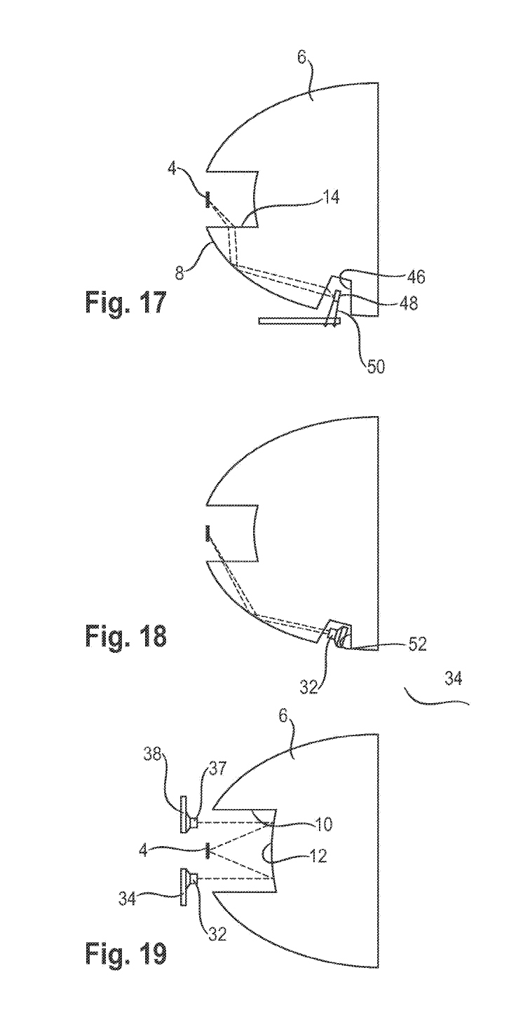

In FIG. 17, provision is made of a cutout 46 which, in contrast to FIGS. 15 and 16, has such a configuration that a sensor 48 may be completely immersed therein. Here, the sensor 48 detects some of the radiation emanating from the conversion element 4, said radiation entering into the optical component 6 via the lateral entrance surface 14 and being reflected at the TIR surface 8. The sensor 48 is contacted by way of connection wires 50 which are guided out of the cutout 46.

FIG. 18 provides a cutout 52 which, in contrast to the cutout in FIG. 17, is configured in such a way that the sensor 32 may be received therein, together with the printed circuit board 34.

In accordance with FIG. 19, the sensors 32, 37 are arranged adjacent to the conversion element 4, together with their printed circuit boards 34 and 38, respectively, and in contrast to FIG. 13. Here, they are situated e.g. in a plane with the conversion element 4, with the plane extending approximately perpendicular to a longitudinal axis of the optical component 6. Here, the sensors 32 and 37 detect some of the radiation emanating from the conversion element 4, said radiation being deflected to the sensors 32 and 34 as Fresnel back reflections of the inner entrance surface 12. In accordance with FIG. 19, both the conversion element and the sensors 32 and 37 are arranged in the entrance region of the input cutout 10.

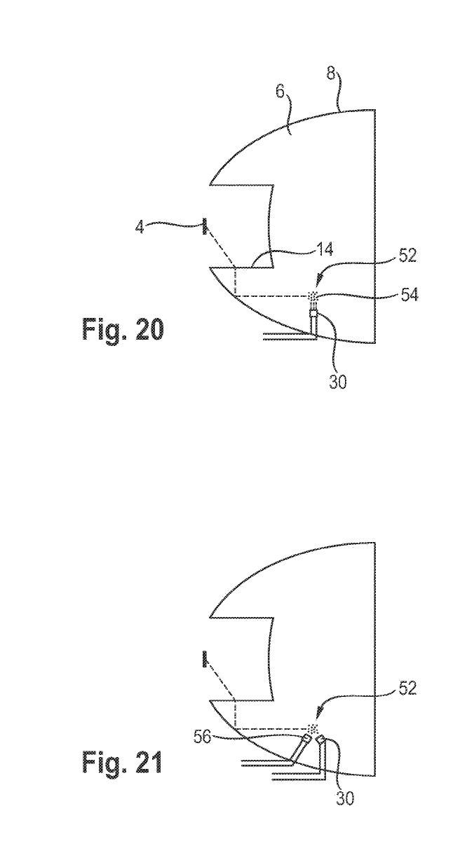

In contrast to FIG. 7, FIG. 20 does not provide a mirror element but a spatial volume 52 within the optical component 6, said spatial volume having scattering centers 54. These deflect some of the radiation emanating from the conversion element 4 to the sensor 30, said radiation being guided via the lateral entrance surface 14 and the TIR surface 8.

In contrast to FIG. 20, two sensors 30, 56 are provided in FIG. 21, said sensors being arranged adjacent to the spatial volume 52.

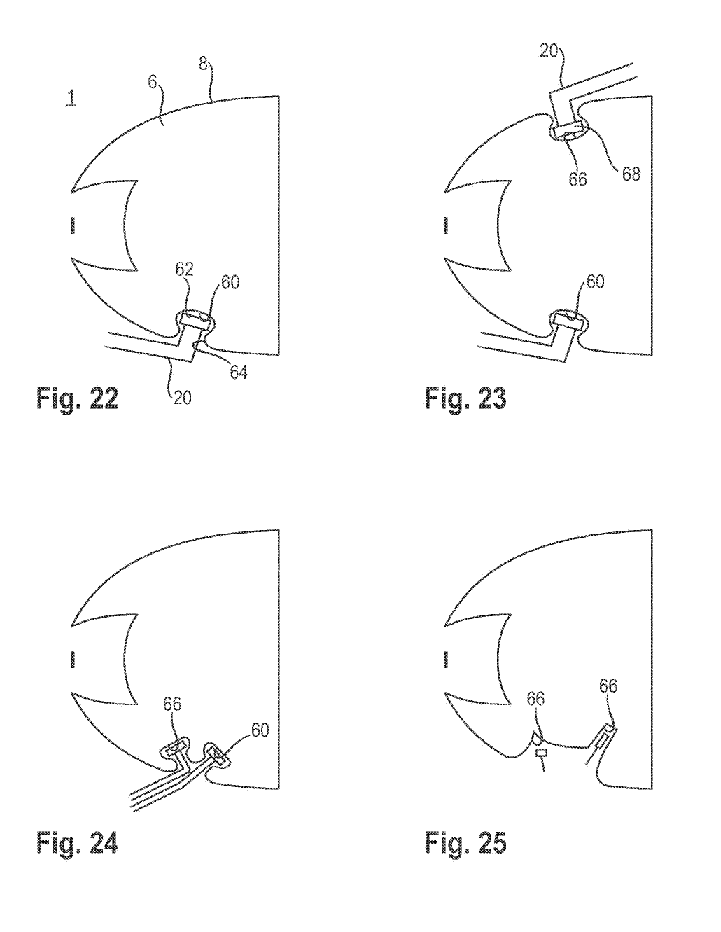

In FIG. 22, the lighting device 1 has a receiving cutout 60 in the optical component 6. Said receiving cutout is open toward the TIR surface 8. A sensor 62 is arranged in the receiving cutout 60. Here, the receiving cutout 60 is configured in such a way that it engages behind the sensor 62. The electrical connectors are guided from the sensor 62 to the outside through an opening 64 of the receiving cutout 60.

In accordance with FIG. 23, a further receiving cutout 66 is provided diametrically in relation to the receiving cutout 60, said further receiving cutout having an appropriate configuration. The latter likewise has a sensor 68 arranged therein, the electrical connectors 20 of which are guided to the outside.

In FIG. 24, the receiving cutouts 60, 66 are arranged adjacent to one another and connected to one another.

FIG. 25 shows the receiving cutouts 60, 66 with a different geometry in comparison with FIG. 24.

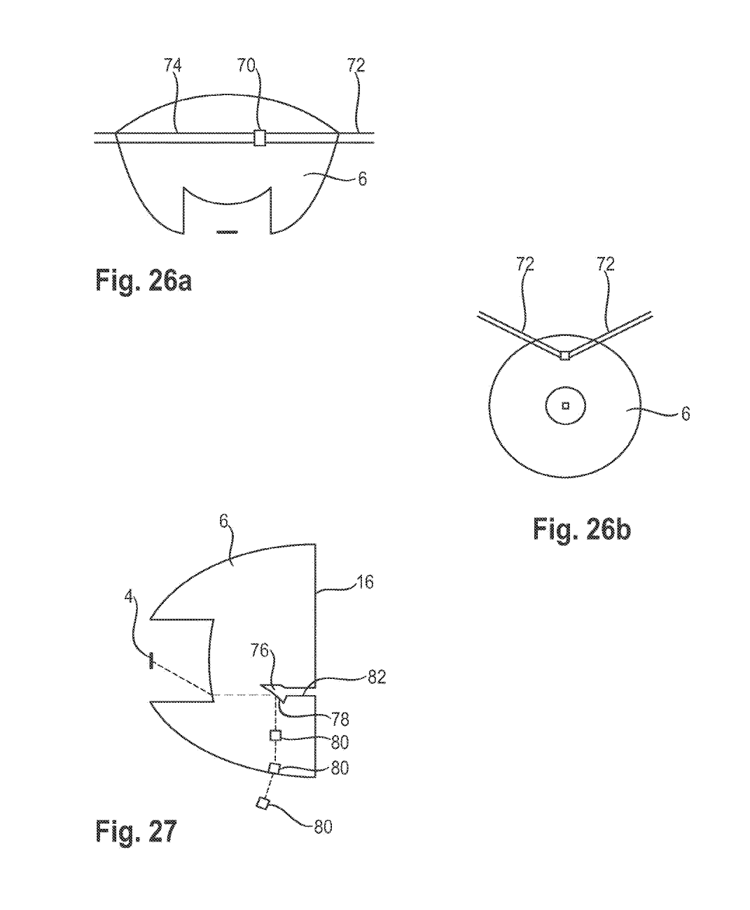

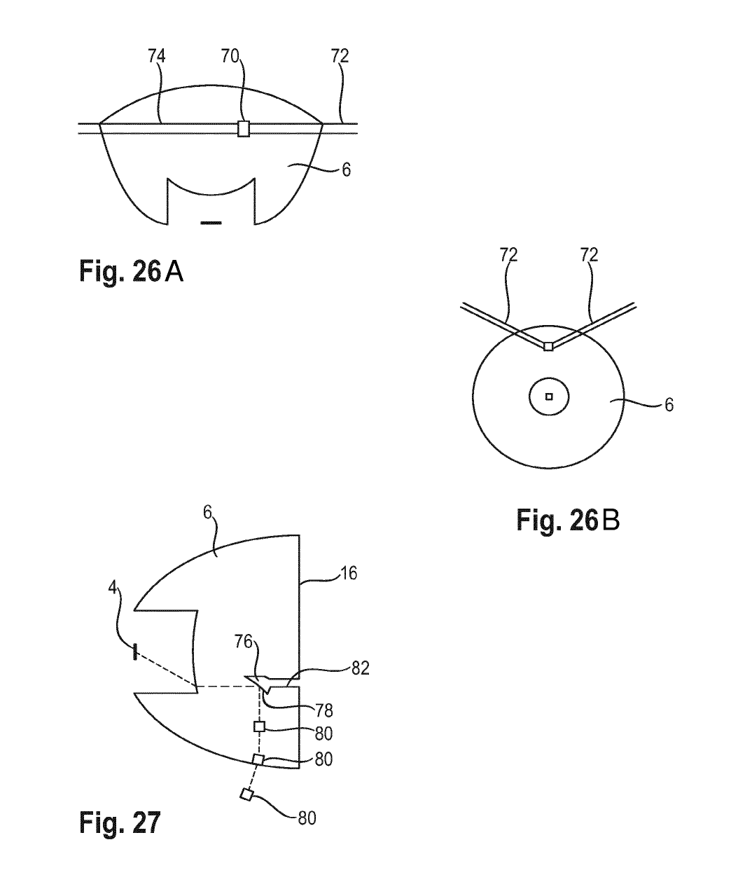

In accordance with FIG. 26A, an element 70, which is e.g. a mirror element or the sensor, is arranged in the optical component 6. Here, the element 70 is insert molded into the optical component 6. Two webs 72, 74 are provided so that the element is stationary within the injection molding method. Said webs extend approximately in a plane which extends approximately perpendicular to the longitudinal axis of the optical component 6. In accordance with FIG. 26B, a V-shaped arrangement of the webs 72 and 74 is identifiable in a front view of the optical component 6.

A cavity 76 is provided instead of a mirror in FIG. 27. Said cavity has a surface 78 at an angle to the longitudinal axis of the optical component 6, said surface acting as a TIR surface and guiding some of the radiation emanating from the conversion element 4 to the sensor element 80. In FIG. 27, three preferred positions of the sensor 80 are shown in an exemplary manner, namely in the optical component 6, in the edge region of the optical component 6, and outside of the optical component 6. The cavity 76 is open to the outside by way of a channel 82. Here, proceeding from the cavity 76, the channel 82 extends approximately at a parallel distance from the longitudinal axis of the optical component 6 and opens into the exit surface 16.

According to the present disclosure, an optical component including a sensor for detecting some of the radiation entering into the optical component is disclosed. Advantageously, a conversion element and an electromagnetic radiation source, in particular a laser light source, are assigned to the optical component.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A lighting device comprising a conversion element, which may be irradiated with excitation radiation from an electromagnetic radiation source, wherein provision is made of an optical component for the radiation emanating from the conversion element, and wherein provision is made of a sensor for detecting radiation emanating from the conversion element and/or for detecting radiation emanating from the radiation source.

2. The lighting device as claimed in claim 1, wherein the optical component consists essentially of silicone.

3. The lighting device as claimed in claim 1, wherein the optical component is a collimator optics.

4. The lighting device as claimed in claim 1, wherein provision is made of a sensor for radiation converted by the conversion element and wherein provision is made of a further sensor for radiation not converted by the conversion element.

5. The lighting device as claimed in claim 1, wherein the sensor is arranged within the optical component or arranged outside of the optical component.

6. The lighting device as claimed in claim 1, wherein the sensor is arranged in such a way that, substantially, radiation reflected from a TIR surface of the optical component impinges on the sensor or that, substantially, radiation directly emanating from the conversion element impinges on the sensor.

7. The lighting device as claimed in any one of the preceding claims claim 1, wherein the sensor is arranged in an edge region of the optical component.

8. The lighting device as claimed in claim 1, wherein the sensor is arranged adjacent to a mechanical functional region of the optical component.

9. The lighting device as claimed in claim 1, wherein a mirror element or a scattering element is arranged in the optical component in such a way that some of the radiation entering into the optical component radiates directly, or via a TIR surface, to the mirror element or to the scattering element and is guided onward thereover to the sensor.

10. The lighting device as claimed in claim 9, wherein some of the radiation entering into the optical component is deflected via the mirror element or the scattering element toward a TIR surface in such a way that this part of the radiation radiates through the TIR surface to the sensor.

11. The lighting device as claimed in claim 5, wherein the sensor is an SMD component arranged on a printed circuit board, wherein the printed circuit board is provided outside of the optical component.

12. The lighting device as claimed in claim 9, wherein the TIR surface comprises a passage so that radiation from the optical component radiates to the sensor.

13. The lighting device as claimed in claim 9, wherein a cutout, which has a round or polygonal cutout surface or a combination of a round and polygonal cutout surface, is introduced into the region of the TIR surface of the optical component.
